(19) United States
(12) Patent Application Publication
(10) Pub. No.: US 2012/0313934 A1
(43) Pub. Date: Dec. 13, 2012

(54) ELECTRONIC DEVICE, DISPLAY CONTROL METHOD AND PROGRAM

(76) Inventor: Yoshitomo Akagi, Osaka-shi (JP)

(21) Appl. No.: 13/579,604

(22) PCT Filed: Nov. 15, 2011
(86) PCT No.: PCT/JP2011/076263

§ 371 Date: Aug. 17, 2012

(30) Foreign Application Priority Data
Nov. 25, 2010 (JP) 2010-262133

(51) Int. Cl. G06T 15/00; G06T 11/00

(52) U.S. Cl. 345/419

(57) ABSTRACT

An electronic device capable of simultaneously displaying in two-dimensional and three-dimensional fashions the same content. A flash memory of the electronic device stores first image data for two-dimensionally displaying the content, and second image data for three-dimensionally displaying the content. A CPU of the electronic device two-dimensionally displays the content on a display of the electronic device, using the first image data. When the CPU accepts an instruction for selecting the content displayed on the display, the CPU three-dimensionally displays the selected content on a display of a display device, using the second image data.

### TECHNICAL FIELD

The present invention relates to an electronic device, a display control method and a program. Particularly, the invention relates to an electronic device storing image data for three-dimensional display, a display control method and a program.

### BACKGROUND ART

Conventionally, devices capable of displaying two-dimensional images and three-dimensional images have been known.

As the above device, Japanese Patent Laying-Open No. 2004-328566 (Patent literature 1) has disclosed a content display device. This content display device is switchable between the two-dimensional display and the three-dimensional display.

As a display method in a device capable of displaying two-dimensional and three-dimensional images, Japanese Patent Laying-Open No. 10-172004 (Patent literature 2) has disclosed a stereoscopic image display method. This stereoscopic image display method reproduces a stereoscopic image by separately inputting an image for the right eye and an image for the left eye to the right and left eyes, respectively. Further, the stereoscopic image display method produces the two images for the left and right eyes, using three-dimensional computer graphics that produces taken images from information describing three-dimensional spaces by a computer. Further, the stereoscopic image display method enables non-stereoscopic display and change to the stereoscopic display state according to changes in amount of parallax between two images for the left and right eyes.

### CITATION LIST

### Patent Literature

PTL 1: Japanese Patent Laying-Open No. 2004-328566
PTL 2: Japanese Patent Laying-Open No. 10-172004

### SUMMARY OF INVENTION

### Technical Problem

However, the technologies of the patent literatures 1 and 2 cannot simultaneously display the same contents in the two-dimensional and three-dimensional fashions. The present invention has been made in view of the above problem, and it is an object of the invention to provide an electronic device, a display control method and a program that can simultaneously display the same contents in the two-dimensional and three-dimensional fashions.

### Solution To Problem

According to an aspect of the invention, an electronic device includes a processor and a memory. The memory stores first image data for two-dimensionally displaying a content and second image data for three-dimensionally displaying the content. The processor two-dimensionally displays the content on a first display, using the first image data. When the processor accepts an instruction for selecting the content displayed on the first display, the processor three-dimensionally displays the selected content on a second display, using the second image data.

Preferably, the memory stores the first image data and the second image data for each of a plurality of the contents. The processor two-dimensionally displays the plurality of contents on the first display. The processor accepts an instruction for selecting one content from among the plurality of contents displayed on the first display. The processor three-dimensionally displays the selected contents on the second display, using the second image data of the selected contents.

Preferably, the first display is a display dedicated to the two-dimensional display.

Preferably, the processor displays each of the plurality of contents as a thumbnail image on the first display. When the processor accepts an instruction for selecting one thumbnail image from among the plurality of thumbnail images, the processor displays the two-dimensional image corresponding to the selected thumbnail image on the first display.

Preferably, the electronic device further includes a touch panel located in a position opposed to a display surface of the first display for sensing a contact position and a contact pressure. When the touch panel senses the contact for selecting the contents, the processor three-dimensionally displays the selected contents on the second display with a projection amount corresponding to the contact pressure based on the contact.

Preferably, the electronic device further includes at least one of the first and second displays.

According to another aspect of the invention, a display control method is a display control method in an electronic device provided with a processor and a memory. The memory stores first image data for two-dimensionally displaying a content and second image data for three-dimensionally displaying the content. The display control method includes the step of: operating the processor two-dimensionally displaying the content on a first display, using the first image data; and the processor three-dimensionally displaying the selected content on a second display, using the second image data, when the processor accepts an instruction for selecting the content displayed on the first display.

According to further another aspect of the invention, a program is a program for controlling an electronic device provided with a processor and a memory. The memory stores first image data for two-dimensionally displaying a content and second image data for three-dimensionally displaying the content. The program operates the processor to execute the step of: two-dimensionally displaying the content on a first display, using the first image data; and three-dimensionally displaying the selected content on a second display, using the second image data, when an instruction for selecting the content displayed on the first display is accepted.

### Advantageous Effects of Invention

According to the invention, it is possible to display simultaneously the same contents in the two-dimensional and three-dimensional fashions.

### BRIEF DESCRIPTION OF DRAWINGS

FIG. 1 is a view showing a schematic structure of an image display system.

FIG. 2 is a view showing a hardware structure of an electronic device.

FIG. 3 is a view showing an example of screen transition in the electronic device and a display device.

FIG. 4 is a view showing display data stored in a flash memory.

FIG. 5 is a flowchart illustrating a flow of processing in the electronic device.

FIG. 6 is a view for performing screen transition in the display device.

FIG. 7 is a view for illustrating a relationship between a contact pressure and an amount of projection of a three-dimensional image.

FIG. 8 is a view showing an outer appearance of another electronic device.

FIG. 9 is a view showing a schematic structure of another image display system.

### DESCRIPTION OF EMBODIMENTS

Embodiments of the invention will now be described with reference to the drawings. In the following description, the same parts bear the same reference numbers. They bear the same names, and achieve the same functions. Therefore, description thereof will not be repeated.

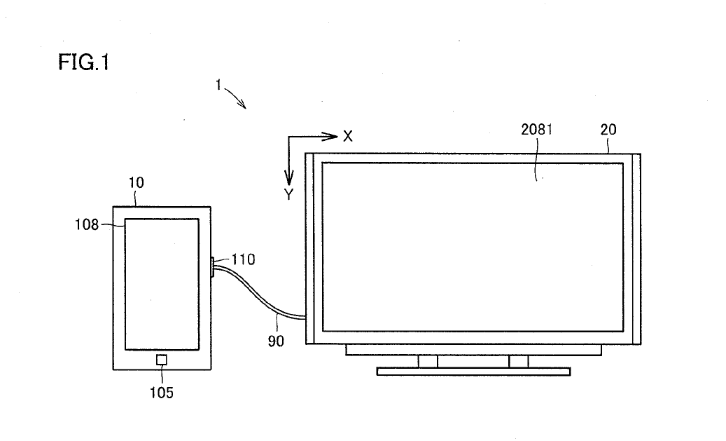

FIG. 1 is a view showing a schematic structure of an image display system 1. Referring to FIG. 1, image display system 1 includes an electronic device 10 and a display device 20. Electronic device 10 includes operation keys 105, a display 108 equipped with a touch panel and an output terminal 110. Display device 20 includes a display 2081 and an input terminal (not shown).

Electronic device 10 is connected to display device 20 via a connection cable 90. Specifically, output terminal 110 of electronic device 10 is connected to the input terminal of display device 20 via connection cable 90. For example, output terminal 110 is an USB (Universal Serial Bus) output terminal, and the input terminal is an USB terminal. Alternatively, output terminal 110 may be an HDMI (High-Definition Multimedia Interface) output terminal, and the input terminal may be an HDMI terminal.

Electronic device 10 is, e.g., a cellular telephone such as a smart phone, a PDA (Personal Digital Assistant) or a photo-viewer. Also, electronic device 10 may be a net-book. Electronic device 10 is a device capable of only two-dimensional display.

Display device 20 is, e.g., an output device such as a television set, a monitor of a personal computer or the like that can output images (still images and moving images). Display device 20 is configured to allow three-dimensional display. Display device 20 displays, on display 2081, right-eye and left-eye images (i.e., images for the right eye and images for the left eye) alternating in an x direction. A method of the three-dimensional display is not particularly restricted. The method of the three-dimensional display may be selected, e.g., from among various methods such as a parallax barrier method, a lenticule method, a polarizing plate method, a liquid crystal active shutter spectacle method and the like.

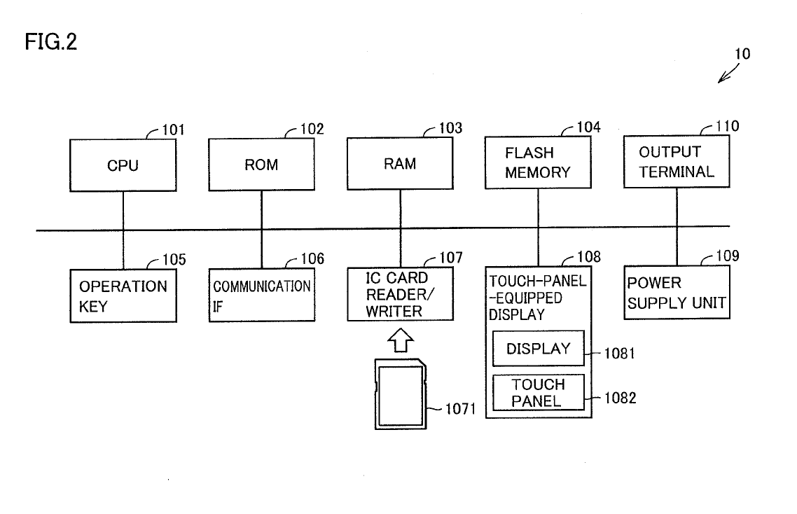

FIG. 2 is a view showing a hardware structure of electronic device 10. Referring to FIG. 2, electronic device 10 includes a CPU (Central Processing Unit) 101 executing programs, an ROM (Read Only Memory) 102 nonvolatilely storing data, an RAM (Random Access Memory) 103 volatilely storing data, a flash memory 104 of an NAND type, operation keys 105 accepting input of instructions of a user of electronic device 10, a communication IF (Interface) 106, an IC (Integrated Circuit) card reader/writer 107, a display 108 equipped with a touch panel, a power supply unit 109 and an output terminal 110. Touch-panel-equipped display 108 is formed of a display 1081 and a touch panel 1082. Touch panel 1082 is located in a position opposed to a display surface of display 1081.

Flash memory 104 is a nonvolatile semiconductor memory. Flash memory 104 volatilely stores various programs for controlling electronic device 10 as well as various data such as data produced by electronic device 10, data obtained from an external device of electronic device 10 and data representing an amount of displacement between the right-eye image and the left-eye image for achieving projection amounts V1, V2 and V3 to be described later.

Communication IF 106 performs the signal processing for performing radio communications by electronic device 10 with external communication devices. Power supply unit 109 supplies an electric power through a data bus to CPU 101, communication IF 106, IC card reader/writer 107, touch-panel-equipped display 108 and the like.

A data bus connects various components 101-110 together. IC card reader/writer 107 is loaded with a memory card 1071.

The processing in electronic device 10 is implemented by software executed by various kinds of hardware and CPU 101. Flash memory 104 may prestore such software. Also, memory card 1071 or another storage medium may store the software for distribution as a program product. Further, information providers connected to the so-called Internet may provide the software as downloadable program products. Such software is read from the storage medium by IC card reader/writer 107 or another reading device, or is downloaded through the communication IF, and then it is temporarily stored in flash memory 104. CPU 101 reads such software from flash memory 104, and further stores it in flash memory 104 in a form of an executable program. CPU 101 executes the program.

Each of the components forming electronic device 10 shown in the figure is of a general type. Therefore, it can be considered that an essential portion of the invention is the software stored in flash memory 104, memory card 1071 or another storage medium, or is the software that can be downloaded over the network. An operation of each item of the hardware of electronic device 10 is well known, and therefore detailed description thereof is not repeated.

The record medium is not restricted to a DVD-ROM, CD-ROM FD (Flexible Disk) or hard disk, and may be a medium statically carrying the programs such as a magnetic tape, cassette tape, optical disc (MO (Magnetic Optical) disc, MD (Mini Disc) or DVD (Digital Versatile Disc)), optical card, mask ROM, EPROM (Electronically Programmable Read-Only Memory), EEPROM (Electronically Erasable Programmable Read-Only Memory), flash ROM or another semiconductor memory. The recording medium is a medium that is non-transitory and allows the computer to read the above program and the like.

The program in this description is not restricted to the program that can be directly executed by the CPU, but includes programs such as a program in a source program form, compressed program or encrypted program.

In the following description, it is assumed that thumbnail images are produced by shrinking original images. An image that three-dimensionally displays contents represented by an original image is referred to as a “three-dimensional image”.

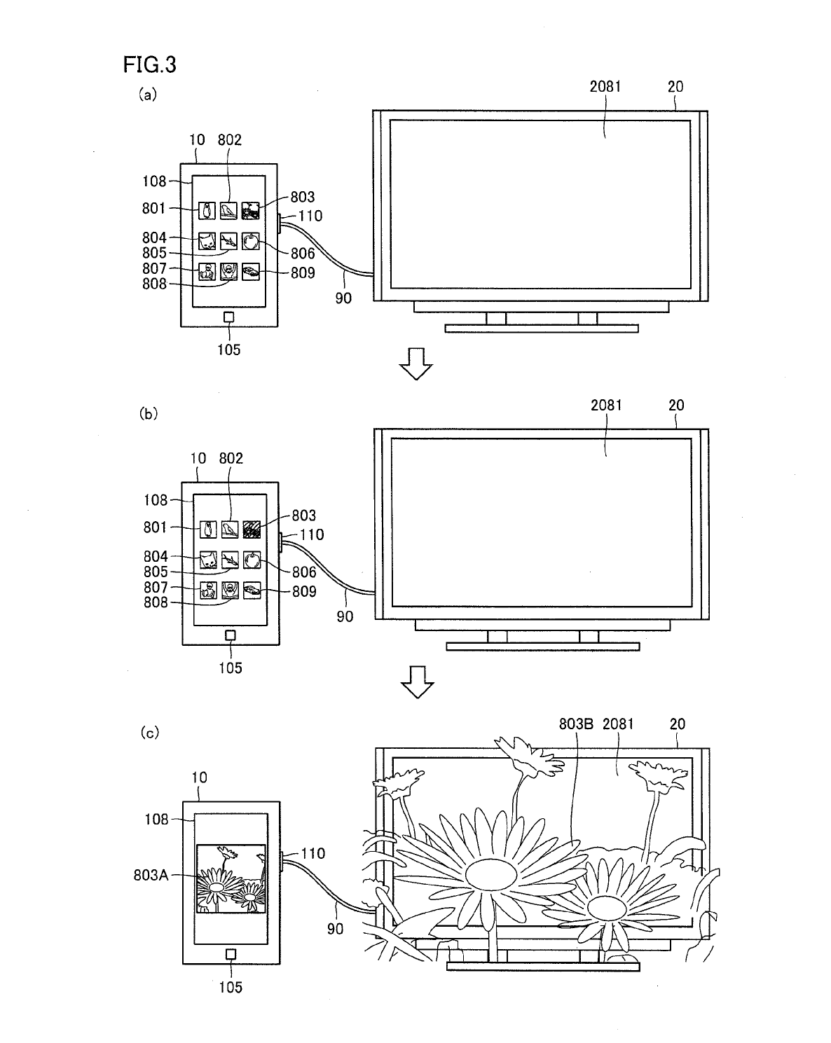

FIG. 3 is a view showing an example of screen transition in electronic device 10 and display device 20. FIG. 3(a) is a view showing a state in which electronic device 10 displays a plurality of thumbnail images. FIG. 3(b) is a view showing a state immediately after one thumbnail image is selected in electronic device 10. FIG. 3(c) is a view showing a state in which electronic device 10 outputs a three-dimensional image to display 208 of display device 20.

Referring to FIG. 3(a), when CPU 101 accepts a predetermined instruction from a user, it displays a plurality of thumbnail images 801-809 on display 1081 of touch-panel equipped display 108. This instruction is provided through touch panel 1082 or the like. Flash memory 104 has stored the plurality of thumbnail images 801-809.

CPU 101 does not output the image to display device 20. Electronic device 10 may be configured such that the image of the same contents as that displayed on display 1081 is provided to display device 20.

Referring to FIG. 3(b), when one of thumbnail images 803 is selected through touch panel 1082, CPU 101 changes screen contents to indicate that thumbnail image 803 is selected. Even in this state, electronic device 10 does not output the image to display device 20.

Referring to FIG. 3(c), CPU 101 operates display 1081 to display two-dimensionally an original image (i.e., the original image before shrinking) that is the original of selected thumbnail image 803, after FIG. 3(b). Further, CPU 101 displays, on display 2081 of display device 20, the three-dimensional image of the same contents as the above original image. Thus, CPU 101 operates such that the same contents are two-dimensionally displayed on display 1081 and are three-dimensionally displayed on display 2081.

The screen shown in FIG. 3(b) is displayed only during a period before electronic device 10 displays the original image as shown in FIG. 3(c).

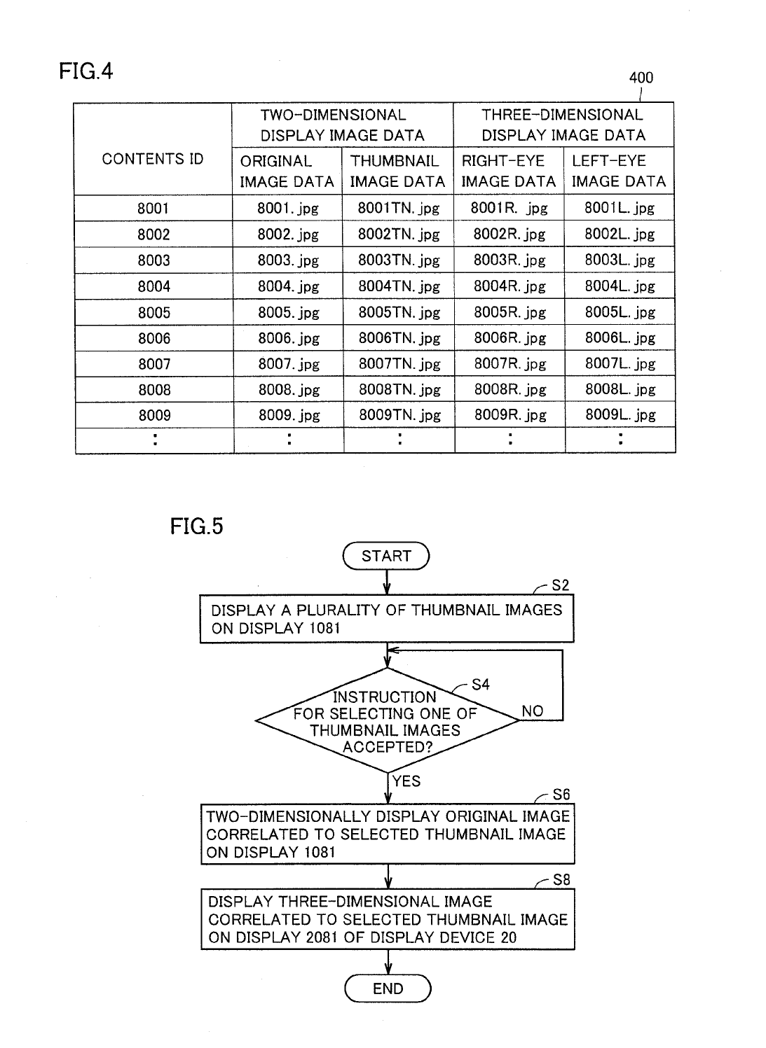

FIG. 4 is a view showing display data 400 (i.e., data for display) stored in flash memory 104. Referring to FIG. 4, flash memory 104 stores the two-dimensional display image data (i.e., image data for two-dimensional display) and the three-dimensional display image data (i.e., image data for three-dimensional display) corresponding to each contents ID (Identification).

The two-dimensional display image data is formed of the original image data and the thumbnail image data. The three-dimensional display image data is formed of the right-eye image data and the left-eye image data. For example, contents ID 8001 is correlated to original image data 8001.jpg, thumbnail image data 8001TN.jpg, right-eye image data 8001R.jpg and right-eye image data 8001L.jpg.

Each content is either a still image or a moving image. Each content can be two-dimensionally displayed according to the two-dimensional display image data, and can be three-dimensionally displayed according to the three-dimensional display image data.

CPU 101 displays a plurality of thumbnail images 801-809 on display 1081 of electronic device 10, using the thumbnail image data. CPU 101 displays an original image 803A correlated to selected thumbnail image 803 on display 1081 of electronic device 10, using the original image data. CPU 101 displays, on display 2081 of display device 20, a three-dimensional image 803B representing the same contents as original image 803A displayed on display 1081 using the three-dimensional display image data. In other words, CPU 101 displays three-dimensional image 803B correlated to selected thumbnail image 803 on display 2081 of display device 20 using the three-dimensional display image data. The file format is not restricted to jpg.

FIG. 5 is a flowchart illustrating a flow of the processing in electronic device 10. Referring to FIG. 5, in a step S2, CPU 101 displays a plurality of thumbnail images on display 1081. In a step S4, CPU 101 determines whether an instruction is accepted to select one from among the plurality of thumbnail images displayed on display 1081 or not.

When CPU 101 determines that the instruction for the selection is accepted (YES in step S4), it two-dimensionally displays the original image corresponding to the selected thumbnail image on display 1081 in a step S6. When CPU 101 determines that the instruction for the selection is not accepted (NO in step S4), it advances the processing to step S4.

In a step S8, CPU 101 outputs the three-dimensional image correlated to the selected thumbnail image to display 2081 of display device 20.

(1) As described above, flash memory 104 has stored the thumbnail image data for two-dimensionally displaying the contents and the three-dimensional display image data for three-dimensionally displaying the contents in question (see FIG. 4).

CPU 101 uses the thumbnail image data to display two-dimensionally the contents on display 1081 as the thumbnail images. When CPU 101 accepts the instruction for selecting the contents displayed on display 1081, it uses the three-dimensional display image data to display three-dimensionally the selected contents in question on display 2081 of display device 20.

Therefore, electronic device 10 two-dimensionally displays the contents on display 1081, and can also three-dimensionally display the contents in question on display 2081. Therefore, the electronic device can simultaneously display the contents in the two- and three-dimensional fashions. Accordingly, the user can simultaneously view the contents as the two-dimensional image and the three-dimensional image.

(2) Further, flash memory 104 stores the thumbnail image data and the three-dimensional display image data for each of the plurality of contents.

CPU 101 two-dimensionally displays each of the plurality of contents as the thumbnail image on display 1081. CPU 101 accepts an instruction for selecting one content from among the plurality of contents displayed on display 1081. CPU 101 three-dimensionally displays the selected content on display 2081 using the three-dimensional display image data of the selected content.

Therefore, electronic device 10 can simultaneously display in the two- and three-dimensional fashions the contents related to the thumbnail image selected by the user.

(3) Display 1081 is a display dedicated to the two-dimensional display.

Therefore, even when electronic device 10 has the structure that cannot three-dimensionally display the contents, the user can view the contents in question in the three-dimensional fashion on another display.

(4) When CPU 101 accepts an instruction for selecting one thumbnail image from among the plurality of thumbnail images, it two-dimensionally displays the original image corresponding to the selected thumbnail image on display 1081.

Therefore, when electronic device 10 displays the three-dimensional image on display 2081 of display device 20, it can display the original image on display 1081. Therefore, the user can view, on display 1081, the original image larger in display size than the thumbnail image, and can view the three-dimensional image on display 2081.

### Modification

(1) Description will be given about the processing of electronic device 10 in the case where touch panel 1082 has a function of sensing a contact pressure at a portion touched with a finger or the like.

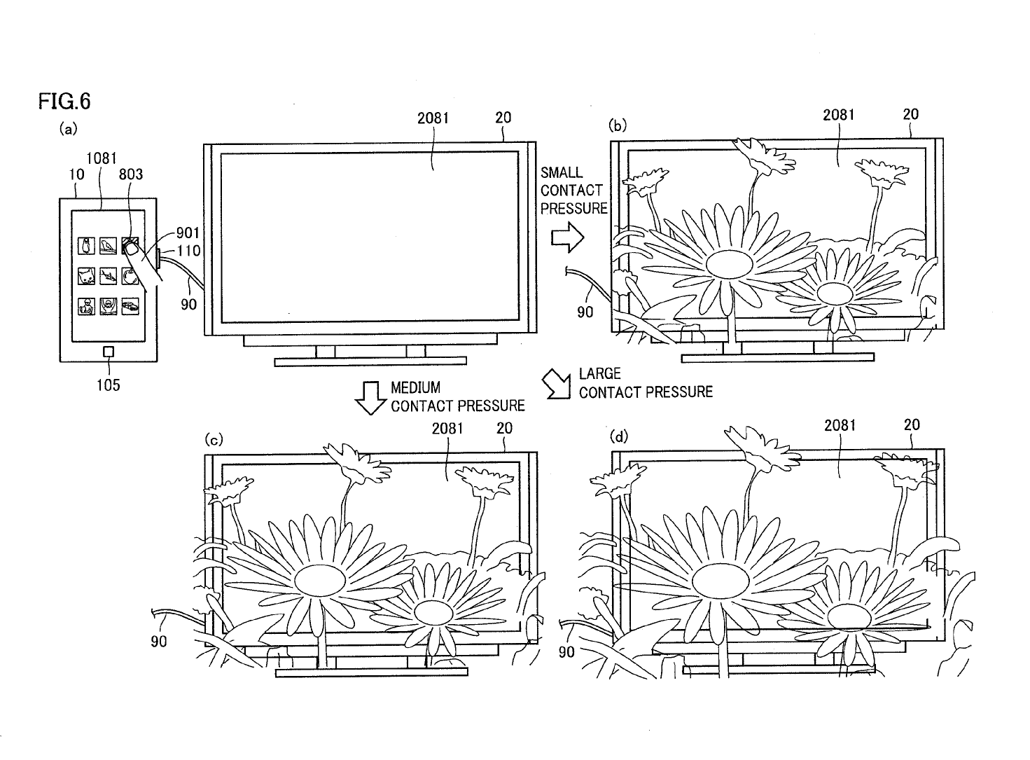

FIG. 6 is a view for performing screen transition in display device 20. FIG. 6(a) is a view showing a state attained immediately after a user selected thumbnail image 803 with a finger 901. FIG. 6(b) is an image displayed on display 2081 after FIG. 6(a), and is an image that is displayed when the user weakly touches touch panel 1082 with finger 901 in FIG. 6(a). FIG. 6(c) is an image displayed on display 2081 after FIG. 6(a), and is an image that is displayed when the user touches touch panel 1082 with finger 901 applying a medium force thereto in FIG. 6(a). FIG. 6(d) is an image displayed on display 2081 after FIG. 6(a), and is an image that is displayed when the user strongly touches touch panel 1082 with finger 901 in FIG. 6(a).

Referring to FIG. 6(b), CPU 101 displays, on display 2081 of display device 20, the three-dimensional image corresponding to selected thumbnail image 803 with a small projection amount. Referring to FIG. 6(c), CPU 101 displays, on display 2081. the three-dimensional image corresponding to selected thumbnail image 803 with a medium projection amount. Referring to FIG. 6(d), CPU 101 displays, on display 2081, the three-dimensional image corresponding to selected thumbnail image 803 with a large projection amount.

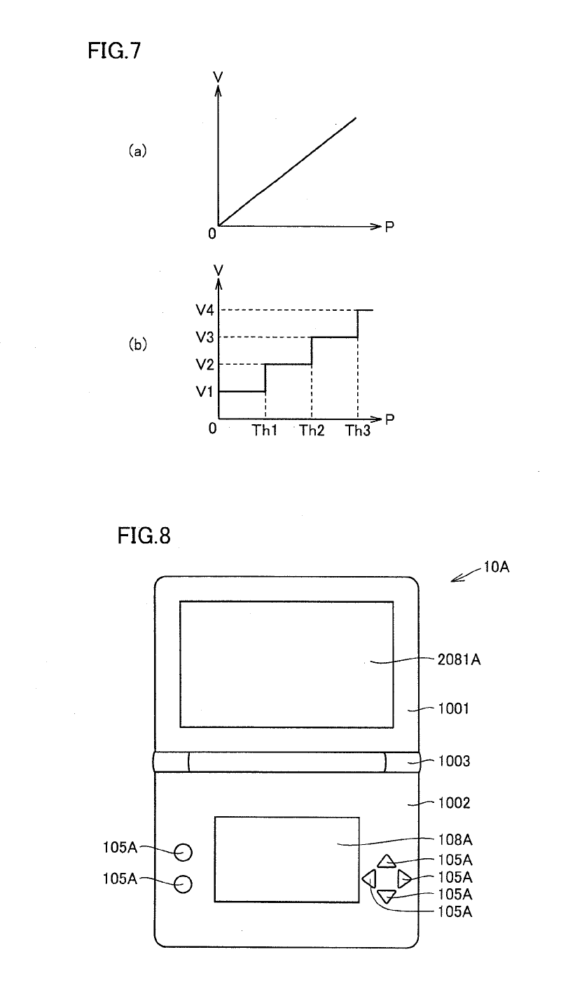

FIG. 7 is a view for illustrating a relationship between contact pressure P and projection amount V of the three-dimensional image. FIG. 7(a) is a graph showing a first relationship between contact pressure P and projection amount V. FIG. 7(b) is a graph showing a second relationship between contact pressure P and projection amount V.

Referring to FIG. 7(a), according to the graph showing the first relationship, projection amount V increases with contact pressure P. CPU 101 displays the three-dimensional image corresponding to selected thumbnail image 803 on display 2081 with the projection amount that is proportional to the sensed contact pressure.

Referring to FIG. 7(b), according to the graph showing the second relationship, projection amount V increases stepwise with contact pressure P. CPU 101 displays the three-dimensional image corresponding to selected thumbnail image 803 on display 2081 with projection amount V that corresponds to sensed contact pressure P.

More specifically, when contact pressure P is smaller than a threshold Th1, CPU 101 displays, on display 2081, the three-dimensional image corresponding to selected thumbnail image 803 with a projection amount V1. When contact pressure P is equal to or larger than threshold Th1 and is smaller than a threshold Th2, CPU 101 displays, on display 2081, the three-dimensional image corresponding to selected thumbnail image 803 with a projection amount V2 (V2>V1). When contact pressure P is equal to or larger than threshold Th2 and is smaller than a threshold Th3, CPU 101 displays, on display 2081, the three-dimensional image corresponding to selected thumbnail image 803 with a projection amount V3 (V3>V2). When contact pressure P is equal to or larger than threshold Th3, CPU 101 displays, on display 2081, the three-dimensional image corresponding to selected thumbnail image 803 with a projection amount V4 (V4>V3).

The control of the projection amount can be achieved by changing a shift between positions of the right-eye image and the left-eye image on display 2081. Increase in this shift can increase the amount of projection, and decrease in this shift can decrease the amount of the projection. Thus, increase in parallax can increase the projection amount, and decrease in parallax can decrease the amount of projection.

As described above, touch panel 1082 senses the contact position and the contact pressure. When touch panel 1082 senses the contact performed for selecting the contents, CPU 101 three-dimensionally displays the selected contents on display 2081 of display device 20 with projection amount V corresponding to contact pressure P based on such contact.

Therefore, the user can three-dimensionally display the contents on display 2081 with a desired projection amount by adjusting the contact pressure of finger 901.

(2) Image display system 1 formed of electronic device 10 and display device 20 has been described by way of example. The following description will be given about a structure in which an electronic device alone can perform the foregoing two-dimensional display and three-dimensional display.

FIG. 8 is a view showing an outer appearance of an electronic device 10A. Referring to FIG. 8, electronic device 10A is of a clamshell type. Electronic device 10A includes a first casing 1001, a second casing 1002 and a hinge member 1003. Hinge member 1003 couples first and second casings 1001 and 1002 together.

First casing 1001 includes a display 2081A capable of three-dimensional display. Second casing 1002 includes a display 108A equipped with a touch panel and operation keys 105A. Touch-panel-equipped display 108A includes display 1081 and touch panel 1082.

When electronic devices 10A and 10 are compared with each other, touch-panel-equipped display 108 of electronic device 10 corresponds to touch-panel-equipped display 108A of electronic device 10A, and display 2081 of display device 20 corresponds to display 2081A of electronic device 10A.

Electronic device 10A includes CPU 101, ROM 102, RAM 103, flash memory 104, operation keys 105A, communication interface 106, IC card reader/writer 107, touch-panel-equipped display 108A and power supply unit 109.

Likewise, in electronic device 10A, CPU 101 two-dimensionally displays the contents as the thumbnail images on display 1081 using the thumbnail image data. When CPU 101 accepts an instruction for selecting the contents displayed on display 1081, it three-dimensionally displays the selected contents on display 2081A using the three-dimensional display image.

More specifically, CPU 101 two-dimensionally displays, on display 1081, each item of the plurality of contents as the thumbnail image. CPU 101 accepts an instruction for selecting one from the plurality of contents displayed on display 1081. CPU 101 three-dimensionally displays the selected contents on display 2081A using the three-dimensional image data of the selected contents.

More specifically, when CPU 101 accepts an instruction for selecting one thumbnail image from among the plurality of thumbnail images, it two-dimensionally displays, on display 1081, the original image corresponding to the selected thumbnail image.

Electronic device 10A may be configured to display three-dimensionally the selected contents on display 2081A with projection amount V that corresponds to contact pressure P based on the contact with touch panel 1082.

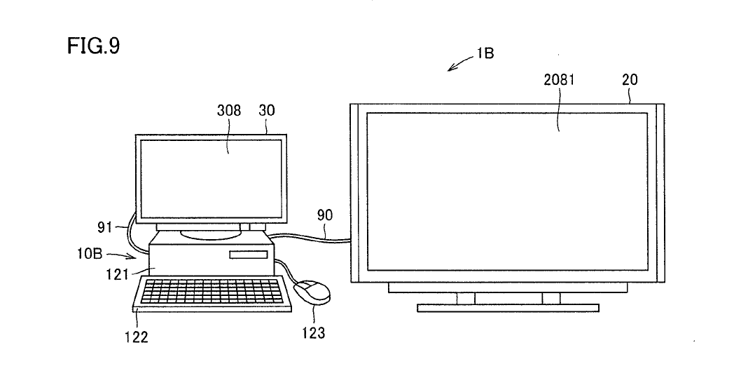

(3) The following description will be given on an image display system 1B different from image display system 1. FIG. 9 is a view showing a schematic structure of image display system 1B. Image display system 1B includes an electronic device 10B, display device 20 and a display device 30. Electronic device 10B includes a main device 121, a keyboard 122 and a mouse 123. Display device 30 includes a touch-panel-equipped display 308. Touch-panel-equipped display 308 includes a display and a touch panel.

Electronic device 10B is connected to display device 20 through connection cable 90. Electronic device 10B is connected to display device 30 through a connection cable 91.

Main device 121 of electronic device 10B includes CPU 101, ROM 102, RAM 103, flash memory 104, keyboard 122, communication interface 106 and IC card reader/writer 107. Electronic device 10B differs from electronic device 10 in that it does not have display means. When image display system 1B is compared with image display system 1, touch-panel-equipped display 108 in electronic device 10 of image display system 1 corresponds to touch-panel-equipped display 308 of display device 30 in image display system 1B.

Likewise, in electronic device 10B, CPU 101 two-dimensionally displays the thumbnail images of the contents on touch-panel-equipped display 308 of display device 30 using the thumbnail image data. When CPU 101 accepts an instruction for selecting the contents displayed on touch-panel-equipped display 308, it three-dimensionally displays the contents thus selected on display 2081 using the three-dimensional display image data. The above instruction is entered through keyboard 122 or mouse 123.

More specifically, CPU 101 two-dimensionally displays, on touch-panel-equipped display 308, each item of the plurality of contents as the thumbnail image. CPU 101 accepts an instruction for selecting one from among the plurality of contents displayed on touch-panel-equipped display 308. CPU 101 three-dimensionally displays the selected contents on display 2081 using the three-dimensional display image data of the selected contents.

Specifically, when CPU 101 accepts the instruction for selecting one thumbnail image from among the plurality of thumbnail images, it two-dimensionally displays, on touch-panel-equipped display 308, the original image corresponding to the selected thumbnail image.

Electronic device 10B may be configured to have a mere display instead of touch-panel-equipped display 308.

Electronic device 10B may be configured such that display 2081 three-dimensionally displays the selected contents with projection amount V corresponding to contact pressure P that is based on the contact with touch-panel-equipped display 308.

(4) In connection with display data 400 in FIG. 4, the configuration that stores the original image data independently of the three-dimensional display data has been described by way of example. However, this is not restrictive, and the right-eye or left-eye image data may be used as the original image data.

(5) Electronic device 10 may be configured as the device capable of two-dimensional display and three-dimensional display. Display device 30 may be configured as the device capable of two-dimensional display and three-dimensional display.

(6) The structure in which display 1081 of electronic device 10 displays the original image correlated to the selected thumbnail image in response to the selection of the thumbnail image has been described by way of example. However, it is not essential to display the original image in question on display 1081. Thus, electronic device 10 may be configured to maintain the display of the thumbnail image.

(7) The thumbnail image data may be configured such that CPU 101 produces the thumbnail image data using the original image data, right-eye image data or left-eye image data based on acceptance of the instruction for displaying the thumbnail image.

(8) Although the structure in which the thumbnail image is selected has been described by way of example, it is not essential that the object to be selected is the thumbnail image. For example, it may be configured to select an icon.

(9) Electronic devices 10, 10A and/or 10B may be configured such that the plurality of original images are displayed instead of the thumbnail images, and displays 2081 and/or 2081A display the three-dimensional image corresponding to the selected original image based on the select of the one original image from among the plurality of original images. Electronic devices 10, 10A and/or 10B may be configured such that only one original image is displayed, and displays 2081 and/or 2081A display the three-dimensional image corresponding to the selected original image based on the select of the plurality of original images.

Although the present invention has been described and illustrated in detail, it is clearly understood that the same is by way of illustration and example only and is not to be taken by way of limitation, the scope of the present invention being interpreted by the terms of the appended claims.

### REFERENCE SIGNS LIST

1 and 1B image display system, 10, 10A and 10B electronic device, 20 and 30 display device, 90 and 91 connection cable, 104 flash memory, 105 and 105A operation key, 108, 108A and 308 touch-panel-equipped display, 110 output terminal, 121 main device, 208, 1081, 2081 and 2081A display, 400 display data, 801-809 thumbnail image, 803A original image, 803B three-dimensional image, 901 finger, 1001 first casing, 1002 second casing, 1003 hinge member, 1082 touch panel

1. An electronic device comprising a processor and a memory,
said memory storing first image data for two-dimensionally displaying a content and second image data for three-dimensionally displaying said content;
said processor two-dimensionally displaying said content on a first display, using said first image data; and
when said processor accepts an instruction for selecting said content displayed on said first display, said processor three-dimensionally displaying said selected content on a second display, using said second image data.

2. The electronic device according to claim 1, wherein
said memory stores said first image data and said second image data for each of a plurality of said contents,
said processor two-dimensionally displays said plurality of contents on said first display,
said processor accepts an instruction for selecting one content from among said plurality of contents displayed on said first display, and
said processor three-dimensionally displays said selected contents on said second display, using said second image data of the selected contents.

3. The electronic device according to claim 1, wherein
said first display is a display dedicated to the two-dimensional display.

4. The electronic device according to claim 3, wherein
said processor displays each of said plurality of contents as a thumbnail image on said first display, and
when said processor accepts an instruction for selecting one thumbnail image from among said plurality of thumbnail images, said processor displays the two-dimensional image corresponding to the selected thumbnail image on said first display.

5. The electronic device according to claim 1, further comprising:
a touch panel located in a position opposed to a display surface of said first display for sensing a contact position and a contact pressure, wherein
when said touch panel senses the contact for selecting said contents, said processor three-dimensionally displays said selected contents on said second display with a projection amount corresponding to the contact pressure based on said contact.

6. The electronic device according to claim 1, further comprising:
at least one of said first and second displays.

7. A display control method in an electronic device provided with a processor and a memory,
said memory storing first image data for two-dimensionally displaying a content and second image data for three-dimensionally displaying said content; and
said display control method comprises the steps of:
said processor two-dimensionally displaying said content on a first display, using said first image data; and
said processor three-dimensionally displaying said selected content on a second display, using said second image data, when said processor accepts an instruction for selecting said content displayed on said first display.

8. A program for controlling an electronic device provided with a processor and a memory,
said memory storing first image data for two-dimensionally displaying a content and second image data for three-dimensionally displaying said content; and
said program operates said processor to execute the steps of:
two-dimensionally displaying said content on a first display, using said first image data; and
three-dimensionally displaying said selected content on a second display, using said second image data, when an instruction for selecting said content displayed on said first display is accepted.
